(19) United States
(12) Patent Application Publication
(10) Pub. No.: US 2020/0069042 A1
(43) Pub. Date: Mar. 5, 2020

(54) METHOD AND SYSTEM FOR LOCALIZATION OF AN ORAL CLEANING DEVICE

(71) Applicant: KONINKLIJKE PHILIPS N.V., Eindhoven (NL)

(72) Inventors: Felipe Maia MASCULO, Eindhoven (NL); Gerben KOOIJMAN, Leende (NL); Toon HARDEMAN, 's-Hertogenbosch (NL); Vincent JEANNE, Mignes Auxances (FR)

(73) Assignee: Koninklijke Phlips N.V., Eindhoven (NL)

(21) Appl. No.: 16/348,305

(22) PCT Filed: Nov. 1, 2017
(86) PCT No.: PCT/IB2017/056783

§ 371 Date: May 8, 2019

Related U.S. Application Data
(60) Provisional application No. 62/420,222, filed on Nov. 10, 2016.

(51) Int. Cl. A46B 15/00; A46B 13/02; A61C 17/22

(52) U.S. Cl. CPC A46B 15/0008; A46B 15/0038; A46B 2200/1066; A61C 17/221; A46B 13/02

(57) ABSTRACT

A method (600) for estimating a location of an oral care cleaning device (10), including the steps of: (i) providing (610) an oral cleaning device comprising a sensor (28), a guidance generator (46), a feedback component (48), and a controller (30); (ii) providing (620) a guided cleaning session to the user comprising a plurality of time intervals separated by a cue to switch from a first location within the mouth to a second location; (iii) generating (630) sensor data from the sensor; (iv) estimating (640), based on the generated sensor data, the location of the oral care device during the plurality of time intervals; (v) generating (650) a model to predict the user's cleaning behavior; and (vi) determining (660) the location of the oral care device based on the estimated location of the oral care device and the model of the user's cleaning behavior.

### FIELD OF THE INVENTION

The present disclosure relates generally to systems and methods for enable accurate localization and tracking of an oral cleaning device during a guided cleaning session having a plurality of distinct time intervals.

### BACKGROUND

Proper tooth cleaning, including length and coverage of brushing, helps ensure long-term dental health. Many dental problems are experienced by individuals who either do not regularly brush or otherwise clean their teeth or who do so inadequately, especially in a particular area or region of the oral cavity. Among individuals who do clean regularly, improper cleaning habits can result in poor coverage of cleaning and thus surfaces that are not adequately cleaned during a cleaning session, even when a standard cleaning regimen, such as brushing for two minutes twice daily, is followed.

To facilitate proper cleaning, it is important to ensure that there is adequate cleaning of all dental surfaces, including areas of the mouth that are hard to reach or that tend to be improperly cleaned during an average cleaning session. One way to ensure adequate coverage is to provide directions to the user guiding the use of the device, and/or to provide feedback to the user during or after a cleaning session. For example, knowing the location of the device in the mouth during a cleaning session is an important means to create enhanced feedback about the cleaning behavior of the user, and/or to adapt one or more characteristics of the device according to the needs of the user. This location information can, for example, be used to determine and provide feedback about cleaning characteristics such as coverage and force.

However, tracking an oral cleaning device during a guided cleaning session has several limitations. For example, compliance of the user with the guidance is required for efficient cleaning. Further, for devices that track the location of the device head within the mouth based at least in part on the guided locations, the localization is typically inaccurate if the user fails to follow the guided session accurately.

Accordingly, there is a continued need in the art for methods and devices that enable accurate localization and tracking of the oral cleaning device during a guided cleaning session.

### SUMMARY OF THE INVENTION

The present disclosure is directed to inventive methods and systems for localization of an oral cleaning device during a guided cleaning session having a plurality of distinct time intervals. Applied to a system configured to provide a guided cleaning session, the inventive methods and systems enable the device or system to track an oral cleaning device during a cleaning session and provide feedback to the user regarding the cleaning session. The system tracks the location of the oral cleaning device during a guided cleaning session comprising a plurality of time intervals separated by a haptic notification to the user that prompts the user to move the device to a new location. Accordingly, the system utilizes motion data from one or more sensors, the pacing and time intervals of the guided cleaning session, and a user behavior model to estimate the location of the oral cleaning device during one or more of the plurality of time intervals of the cleaning session. The system can use the localization information to evaluate the cleaning session and optionally provide feedback to the user.

Generally in one aspect, a method for estimating a location of an oral care device during a guided cleaning session comprising a plurality of time intervals is provided. The method includes the steps of: (i) providing an oral cleaning device comprising a sensor, a guidance generator, a feedback component, and a controller; (ii) providing, by the guidance generator, a guided cleaning session to the user, wherein the guided cleaning session comprises a plurality of time intervals separated by a cue to switch from a first location within the mouth to a second location within the mouth, wherein the cue is generated by the feedback component; (iii) generating, during one of the plurality of time intervals, sensor data from the sensor indicating a position or motion of the oral cleaning device; (iv) estimating, by the controller based on the generated sensor data, the location of the oral care device during the one of the plurality of time intervals; (v) generating a model to predict the user's cleaning behavior; and (vi) determining the location of the oral care device during the one of the plurality of time intervals, based on the estimated location of the oral care device and the model of the user's cleaning behavior.

According to an embodiment, the method further includes the step of providing feedback to the user regarding the cleaning session.

According to an embodiment, the estimating step comprises estimating a probability for each of a plurality of locations within the user's mouth, that the oral care device was located within the location during the one of the plurality of time intervals. According to an embodiment, the estimating step comprises a statistical model or a set of rules.

According to an embodiment, the guided cleaning session further comprises a cue to begin the cleaning session and a cue to end the cleaning session. According to an embodiment, the guided cleaning session comprises only the cues. According to an embodiment, the cue is a visual cue, an audible cue, or a haptic cue.

According to an aspect, a cleaning device configured to estimate a location of the device during a guided cleaning session comprising a plurality of time intervals is provided. The oral cleaning device comprises: a guidance generator configured to provide the guided cleaning session to the user, wherein the guided cleaning session comprises a plurality of time intervals separated by a cue to switch from a first location within the mouth to a second location within the mouth; a sensor configured to generate sensor data during one of the plurality of time intervals, wherein the sensor data indicates a position or motion of the cleaning device; a feedback component configured to generate the cues; and a controller configured to: (i) estimate, based on the generated sensor data, the location of the oral care device during the one of the plurality of time intervals; (ii) generate a model to predict the user's cleaning behavior; and (iii) determine the location of the oral care device during the one of the plurality of time intervals, based on the estimated location of the oral care device and the model of the user's cleaning behavior.

According to an aspect, a cleaning device configured to determine a user's compliance with a guided cleaning session is provided. The cleaning device includes: (i) a guidance generator module configured to generate a guided cleaning session comprising a plurality of time intervals separated by a cue to switch from a first location within the mouth to a second location within the mouth; (ii) a sensor module configured to receive from a sensor, sensor data during one of the plurality of time intervals, wherein the sensor data indicates a position or motion of the cleaning device; (iii) a feature extraction module configured to extract one or more features from the guided cleaning session and the sensor data; (iv) a behavior model module configured to generate a model to predict the user's cleaning behavior; and (v) a location estimator module configured to determine, based on the estimated location of the oral care device and the model of the user's cleaning behavior, the location of the oral care device during the one of the plurality of time intervals.

According to an embodiment, the cleaning device further includes a guidance database comprising one or more stored guided cleaning sessions.

As used herein for purposes of the present disclosure, the term “controller” is used generally to describe various apparatus relating to the operation of a stream probe apparatus, system, or method. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present disclosure discussed herein. The terms “program” or “computer program” are used herein in a generic sense to refer to any type of computer code (e.g., software or microcode) that can be employed to program one or more processors or controllers.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

These and other aspects of the invention will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic representation of an oral cleaning device, in accordance with an embodiment.

FIG. 2 is a schematic representation of an oral cleaning system, in accordance with an embodiment.

FIG. 3 is a schematic representation of an oral cleaning system, in accordance with an embodiment.

FIG. 4 is a schematic representation of a Hidden Markov Model for estimating the location of an oral cleaning device, in accordance with an embodiment.

FIG. 5 is a graph of location probabilities during a guided cleaning session, in accordance with an embodiment.

FIG. 6 is a flowchart of a method for localizing an oral cleaning device during a guided cleaning session having a plurality of distinct time intervals, in accordance with an embodiment.

### DETAILED DESCRIPTION OF EMBODIMENTS

The present disclosure describes various embodiments of a method and device for localizing an oral cleaning device during a guided cleaning session having a plurality of distinct time intervals. More generally, Applicant has recognized and appreciated that it would be beneficial to provide a system configured to evaluate a cleaning session and provide feedback to a user. Accordingly, the methods described or otherwise envisioned herein provide an oral cleaning device configured to provide a guided cleaning session to a user comprising a plurality of distinct time intervals separated by a haptic notification, to obtain sensor data from one or more sensors, and to estimate the location of the oral cleaning device during each of the plurality of distinct time intervals. According to an embodiment, the guided cleaning session comprises a plurality of distinct time intervals separated by a haptic notification, but does not comprise localization instructions, and thus the user is free to choose what sections of the mouth are cleaned in what order. According to an embodiment, the oral cleaning device evaluates the cleaning session based on the estimated location data, and optionally comprises a feedback mechanism to provide feedback to the user regarding the cleaning session.

The embodiments and implementations disclosed or otherwise envisioned herein can be utilized with any oral device, including but not limited to a toothbrush, a flossing device such as a Philips AirFloss®, an oral irrigator, or any other oral device. One particular goal of utilization of the embodiments and implementations herein is to provide cleaning information and feedback using an oral cleaning device such as, e.g., a Philips Sonicare® toothbrush (manufactured by Koninklijke Philips Electronics, N.V.). However, the disclosure is not limited to a toothbrush and thus the disclosure and embodiments disclosed herein can encompass any oral care device.

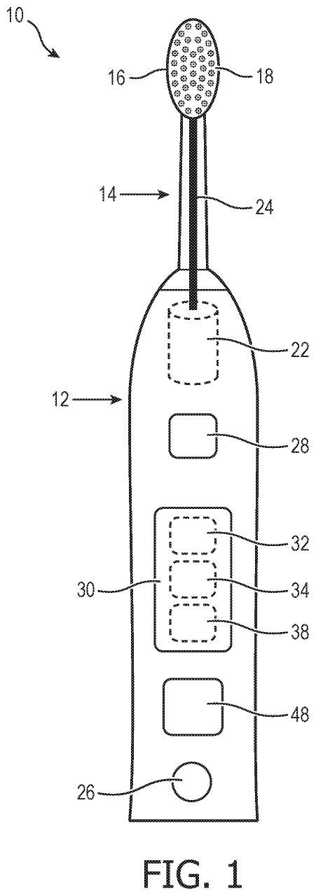

Referring to FIG. 1, in one embodiment, an oral cleaning device 10 is provided that includes a body portion 12 and a device head member 14 mounted on the body portion. Device head member 14 includes at its end remote from the body portion a head 16. Head 16 includes a face 18, which is used for cleaning.

According to an embodiment, device head member 14, head 16, and/or face 18 are mounted so as to be able to move relative to the body portion 12. The movement can be any of a variety of different movements, including vibrations or rotation, among others. According to one embodiment, device head member 14 is mounted to the body so as to be able to vibrate relative to body portion 12, or, as another example, head 16 is mounted to device head member 14 so as to be able to vibrate relative to body portion 12. The device head member 14 can be fixedly mounted onto body portion 12, or it may alternatively be detachably mounted so that device head member 14 can be replaced with a new one when a component of the device are worn out and require replacement.

According to an embodiment, body portion 12 includes a drivetrain 22 for generating movement and a transmission component 24 for transmitting the generated movements to device head member 14. For example, drivetrain 22 can comprise a motor or electromagnet(s) that generates movement of the transmission component 24, which is subsequently transmitted to the device head member 14. Drivetrain 22 can include components such as a power supply, an oscillator, and one or more electromagnets, among other components. In this embodiment the power supply comprises one or more rechargeable batteries, not shown, which can, for example, be electrically charged in a charging holder in which oral cleaning device 10 is placed when not in use.

Although in the embodiment shown in some of the Figures herein the oral cleaning device 10 is an electric toothbrush, it will be understood that in an alternative embodiment the oral cleaning device can be a manual toothbrush (not shown). In such an arrangement, the manual toothbrush has electrical components, but the brush head is not mechanically actuated by an electrical component. Additionally, the oral cleaning device 10 can be any one of a number of oral cleaning devices, such as a flossing device, an oral irrigator, or any other oral care device.

Body portion 12 is further provided with a user input 26 to activate and de-activate movement generator 22. The user input 26 allows a user to operate the oral cleaning device 10, for example to turn it on and off. The user input 26 may, for example, be a button, touch screen, or switch.

The oral cleaning device 10 includes one or more sensors 28. Sensor 28 is shown in FIG. 1 within body portion 12, but may be located anywhere within the device, including for example within device head member 14 or head 16. The sensors 28 can comprise, for example, a 6-axis or a 9-axis spatial sensor system, and can include one or more of an accelerometer, a gyroscope, and/or a magnetometer to provide readings relative to axes of motion of the oral cleaning device, and to characterize the orientation and displacement of the device. For example, the sensor 28 can be configured to provide readings of six axes of relative motion (three axes translation and three axes rotation), using for example a 3-axis gyroscope and a 3-axis accelerometer. Many other configurations are possible. Other sensors may be utilized either alone or in conjunction with these sensors, including but not limited to a pressure sensor (e.g. Hall effect sensor) and other types of sensors, such as a sensor measuring electromagnetic waveforms on a predefined range of wavelengths, a capacitive sensor, a camera, a photocell, a visible light sensor, a near-infrared sensor, a radio wave sensor, and/or one or more other types of sensors. Many different types of sensors could be utilized, as described or otherwise envisioned herein. According to an embodiment, these additional sensors provide complementary information about the position of the device with respect to a user's body part, a fixed point, and/or one or more other positions. According to an embodiment, sensor 28 is disposed in a predefined position and orientation in the oral cleaning device 10, and the brush head is in a fixed spatial relative arrangement to sensor 28. Therefore, the orientation and position of the brush head can be easily determined based on the known orientation and position of the sensor 28.

According to an embodiment, sensor 28 is configured to generate information indicative of the acceleration and angular orientation of the oral cleaning device 10. For example, the sensor system may comprise two or more sensors 28 that function together as a 6-axis or a 9-axis spatial sensor system. According to another embodiment, an integrated 9-axis spatial sensor can provide space savings in an oral cleaning device 10.

The information generated by the first sensor 28 is provided to a controller 30. Controller 30 may be formed of one or multiple modules, and is configured to operate the oral cleaning device 10 in response to an input, such as input obtained via user input 26. According to an embodiment, the sensor 28 is integral to the controller 30. Controller 30 can comprise, for example, at least a processor 32, a memory 34, and a connectivity module 38. The processor 32 may take any suitable form, including but not limited to a microcontroller, multiple microcontrollers, circuitry, a single processor, or plural processors. The memory 34 can take any suitable form, including a non-volatile memory and/or RAM. The non-volatile memory may include read only memory (ROM), a hard disk drive (HDD), or a solid state drive (SSD). The memory can store, among other things, an operating system. The RAM is used by the processor for the temporary storage of data. According to an embodiment, an operating system may contain code which, when executed by controller 30, controls operation of the hardware components of oral cleaning device 10. According to an embodiment, connectivity module 38 transmits collected sensor data, and can be any module, device, or means capable of transmitting a wired or wireless signal, including but not limited to a Wi-Fi, Bluetooth, near field communication, and/or cellular module.

According to an embodiment, oral cleaning device 10 includes a feedback component 48 configured to provide information to the user. For example, the feedback component may be a visual feedback component 48 that provides one or more visual cues to the user that they should switch from the current cleaning location to a new cleaning location. As another example, the feedback component may be an audible feedback component 48 that provides one or more audible cues to the user that they should switch from the current cleaning location to a new cleaning location. As another example, the feedback component may be a haptic feedback component 48, such as any vibrator, that will vibrate to indicate that the user, who is holding the device, should switch from the current cleaning location to a new cleaning location. Alternatively, the feedback component 48 may comprise a distinguishable visual cue, audible cue, or vibration to indicate that the cleaning session should start, as well as a distinguishable visual cue, audible cue, or vibration to indicate that the cleaning session should end. According to an embodiment, therefore, feedback component 48 and/or controller 30 comprises a timer configured to track the plurality of distinct time intervals and provide the necessary feedback at the appropriate intervals.

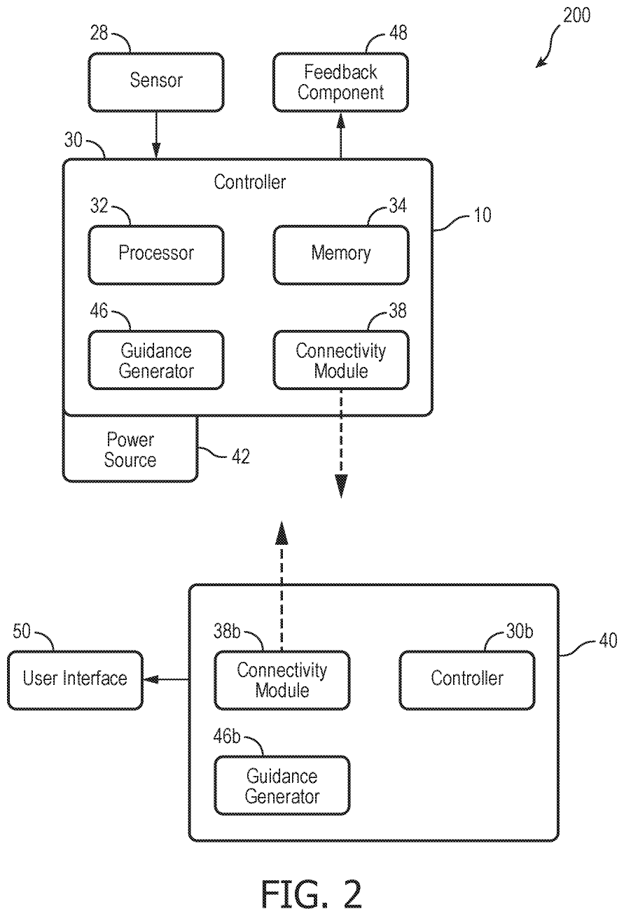

Referring to FIG. 2, in one embodiment, is an oral cleaning system 200 comprising an oral cleaning device 10 and an optional remote device 40 which is separate from the oral cleaning device. The oral cleaning device 10 can be any of the oral cleaning device embodiments disclosed or otherwise envisioned herein. For example, according to an embodiment, oral cleaning device 10 includes one or more sensors 28, a controller 30 comprising a processor 32, and a power source 42. Oral cleaning device 10 also comprises a connectivity module 38. The connectivity module 38 transmits collected sensor information, including to remote device 40, and can be any module, device, or means capable of transmitting a wired or wireless signal, including but not limited to a Wi-Fi, Bluetooth, near field communication, and/or cellular module.

Oral cleaning device 10 also comprises a guidance generator 46 configured to generate guidance instructions to the user before, during, and/or after a cleaning session. The guidance instructions can be extracted from or based on, for example, a predetermined cleaning routine, and/or from information about one or more previous cleaning sessions. The guidance instructions comprise, for example, a visual cue, audible cue, or haptic cue to indicate that the cleaning session should start, a plurality of paced cues during the cleaning session to indicate to the user that they should switch from a current location to a new location not previously cleaned, as well as a visual cue, audible cue, or haptic cue to indicate that the cleaning session should end.

According to an embodiment, remote device 40 can be any device configured to or capable of communicating with oral cleaning device 10. For example, remote device 40 may be a cleaning device holder or station, a smartphone device, a computer, a tablet, a server, or any other computerized device. According to an embodiment, remote device 40 includes a communications module 38b which can be any module, device, or means capable of receiving a wired or wireless signal, including but not limited to a Wi-Fi, Bluetooth, near field communication, and/or cellular module. Device 40 also includes a controller 30b which uses the received information from sensor 28 sent via connectivity module 38. According to an embodiment, remote device 40 includes a user interface 50 configured to provide guided cleaning session instructions to a user, such as information about when to switch from cleaning a current location in the mouth to a new location not previously cleaned. User interface 50 can take many different forms, such as a haptic interface, a visual interface, an audible interface, or other forms. According to an embodiment, remote device 40 can also include a guidance generator 46b configured to generate guidance instructions to the user before, during, and/or after a cleaning session. The guidance instructions can be extracted from or based on, for example, a predetermined cleaning routine, and/or from information about one or more previous cleaning sessions.

For example, remote device 40 can be the user's smartphone, a laptop, a handheld or wearable computer, or a portable instruction device. The smartphone generates cleaning instructions via the guidance generator 46b, which could be, for example, a smartphone app, and provides the cleaning instructions to the user via the smartphone speakers and/or the visual display. According to an embodiment, the oral cleaning device 10 obtains sensor data from sensor 28 during the guided cleaning session representative of localization data for the oral cleaning device, and sends that data to controller 30 of the oral cleaning device and/or controller 30b of the remote device.

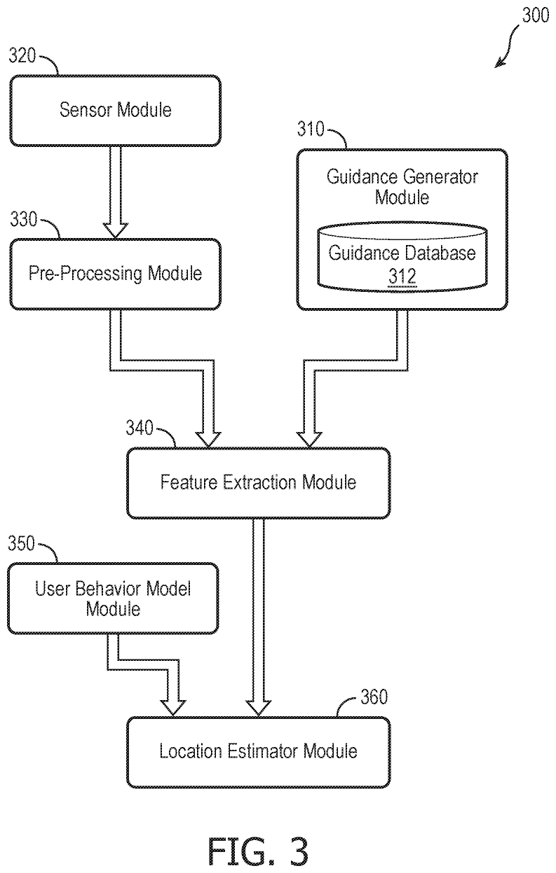

Referring to FIG. 3, in one embodiment, is an oral cleaning system 300. Oral cleaning system 300 is an embodiment of oral cleaning device 10, which can be any of the oral cleaning device embodiments disclosed or otherwise envisioned herein. According to an embodiment, the oral cleaning device provides the user with a guided cleaning session including a plurality of cleaning instructions, where the user receives a notification to move from one area of the mouth to another area, without receiving information about which area to go next. Optionally, the user also receives a notification about when to start the session and when to end the session. Thus, the user only has to move in response to the notification in order to be fully compliant with the guided cleaning session. By avoiding location directions, significantly more freedom is given to the user. This results in an increased level of user compliance.

According to an embodiment, the guided cleaning session divides the mouth into, for example, six segments and the session informs the user when to move from the current segment to the next. As described herein, the system then attempts to determine which mouth segment was cleaned during each of the six intervals. Once the mouth segments corresponding to the six intervals have been estimated, location feedback with higher resolution can be given to the user. It can be appreciated that many other segment numbers are possible.

According to an embodiment of oral cleaning system 300, guidance generator module 310 of oral cleaning system 300 creates one or more cleaning instructions for the user before, during, and/or after a cleaning session. The guidance instructions can be extracted from or based on, for example, a predetermined cleaning routine, and/or from information about one or more previous cleaning sessions. For example, guidance generator module 310 may comprise or be in wired and/or wireless communication with a guidance database 312 comprising information about one or more cleaning routines. According to an embodiment, the guidance instructions comprise a start cue, such as a visual, audible, and/or haptic cue, a plurality of switch cues informing the user to move the device from a first location within the mouth to a new location within the mouth, and/or a stop cue.

Sensor module 320 of oral cleaning system 300 directs or obtains sensor data from sensor 28 of the device, which could be, for example, an Inertial Measurement Unit (IMU) consisting of a gyroscope, accelerometer, and/or magnetometer. The sensor data contains information about the device's movements.

Pre-processing module 330 of oral cleaning system 300 receives and processes the sensor data from sensor module 320. According to an embodiment, pre-processing consists of steps such as filtering to reduce the impact of motor driving signals on the motion sensor, down-sampling to reduce the communication bandwidth, and gyroscope offset calibration. These steps improve and normalize the obtained sensor data.

Feature extraction module 340 of oral cleaning system 300 generates one or more features from the pre-processed sensor signals from pre-processing module 330, and from the guidance instructions from guidance generator module 310. These features provide information related to the location of head 16 within the user's mouth. According to an embodiment, a feature can be computed by aggregating signals over time. For example, features can be computed at the end of a cleaning session, at the end of every guidance interval, every x number of seconds, or at other intervals or in response to other events.

The data from a typical cleaning session comprises thousands of sensor measurements. The feature extraction module 340 applies signal processing techniques to these sensor measurements in order to obtain fewer values, called features, which contain the relevant information necessary to predict whether or not the user was compliant to guidance. These features are typically related to the user's motions and to the device's orientation. Among other features, the feature extraction module 340 can generate the following features: (i) the average device orientation; (ii) the variance of the device's orientation; (iii) the energy in the signals from the motion sensor 28; (iv) the energy in the motion sensor's signals per frequency band; (v) the average force applied to the teeth; (vi) the duration of the cleaning session, and many more.

According to an embodiment, the first step in feature extraction is estimation of the orientation of oral cleaning device 10 with respect to the user's head. Based on signals from the one or more sensors 28, it is possible to determine or estimate the orientation of the device with respect to the world. Furthermore, information about the orientation of the user's head can be determined or estimated from the guidance intervals during which the user was expected to clean at the molar segments. During these intervals, for example, the average direction of the main axis of the device is aligned with the direction of the user's face. Practical tests demonstrate that the average orientation of the device is strongly related to the area of the mouth being cleaned. For example, when cleaning the upper jaw the average orientation of the brush is upwards, and when cleaning the lower jaw the average orientation of the oral cleaning device is downwards. Similarly, the main axis of the oral cleaning device points toward the left (right) when the user is cleaning the right (left) side of the mouth. The relationship between the average orientation of the device and the area of the mouth being cleaned can be exploited to extract features during each of a plurality of guided cleaning session intervals.

User behavior model module 350 comprises a model used to predict the user's cleaning behavior. According to an embodiment, the model is a statistical model such as a Hidden Markov Model or a set of constraints for the cleaning path, order in which the mouth segments are brushed, such as: (i) the user cleans each mouth segment exactly once; or (ii) the user always starts in the lower left quadrant, among many other possible constraints.

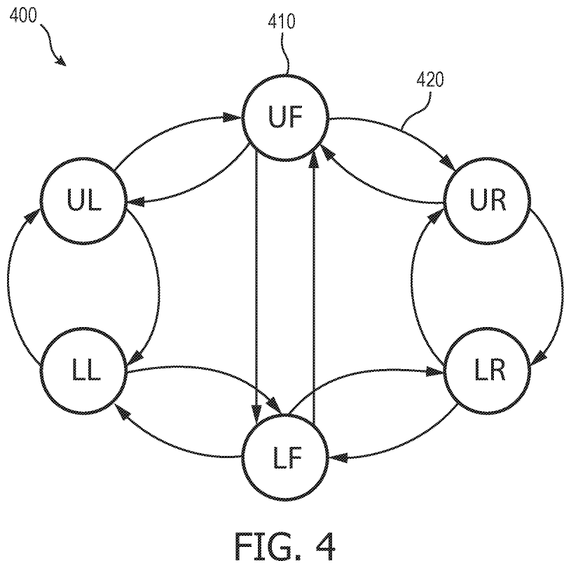

According to an embodiment, it is expected that the users' cleaning behavior will follow certain patterns which can be used as a source of information for the location estimator. For example, at the end of a timed interval during the guided cleaning session, the user is more likely to move to a mouth segment neighboring the segment the user was previously cleaning. This knowledge could be used, for example, by requiring the estimated cleaning path to be from a predefined set of allowed paths. According to an embodiment, a more flexible way to model this knowledge is by means of a Hidden Markov Model, which is a statistical model used for temporal pattern recognition. Referring to FIG. 4, in one embodiment, is an example of a Hidden Markov Model 400 used to model cleaning behavior. Each circle 410 in the model represents a mouth segment, such as upper front (UF), upper right (UR), lower left (LL), and so on. The arrows 420 represent allowed transitions, wherein each transition comprises an associated probability indicating how often the user goes from one segment to the other. In addition to the Hidden Markov Model, many other statistical and/or rule-based models are possible.

Location estimator module 360 of oral cleaning system 300 comprises a classification model that estimates the location of the oral cleaning device in the mouth based on the computed signal features. According to an embodiment, the module compares the measured signals from a given guided cleaning session interval against typical signal patterns per location. The result of this comparison is used in combination with prior knowledge of typical user behavior to determine the most probable mouth location during the interval.

The first step in the estimation is a classification model used to estimate probabilities for the mouth segments given the sensor data. For example, given a set of features from the feature extraction module 340, the classification model estimates the location of the oral cleaning device in the mouth. For example, the model may be Gaussian models, decision trees, support vector machines, and more. According to an embodiment, the parameters of the model are learned from training data, such as a set of labeled examples including data from lab tests during which the location of the oral cleaning device in the mouth was accurately measured. According to an embodiment, the output of the classifier comprises a vector of probabilities.

The second step in the estimation by the location estimator module 360 of oral cleaning system 300 is combining the probabilities created at the classifier step with the user model generated by behavior model module 350. For example, if the behavior model is a Hidden Markov Model, the output of the classifier can be seen as emission probabilities and the most likely path can be obtained with a Viterbi algorithm, among other methods. As another example, if the behavior model comprises a predefined set of allowed paths, then the predicted path is the valid path that maximizes the product of segment probabilities.

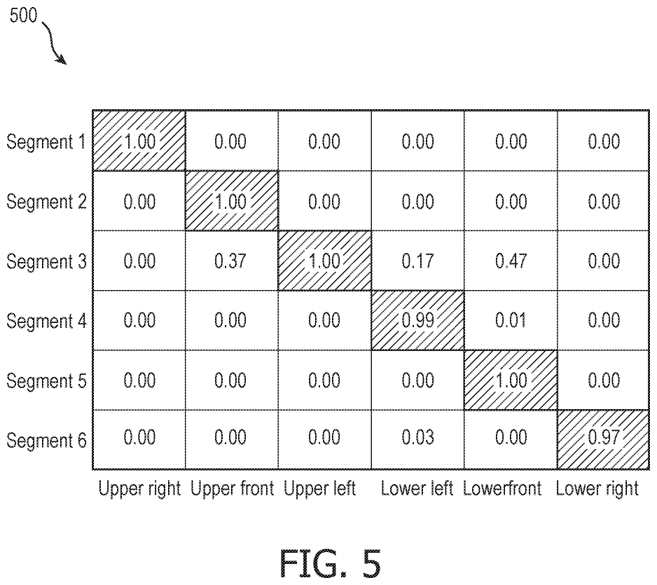

Referring to FIG. 5, in one embodiment, is a graph 500 of location probabilities for a mouth divided into six quadrants. According to this embodiment, the set of allowed paths contains all paths without repetitions, such that each mouth segment is brushed exactly once. The rows of the graph correspond to each of six guided cleaning intervals, and each cell comprises the probability, in turn, that the user was cleaning the possible six segments. The highlighted cells indicate the most probable path according to a behavior model generated by behavior model module 350.

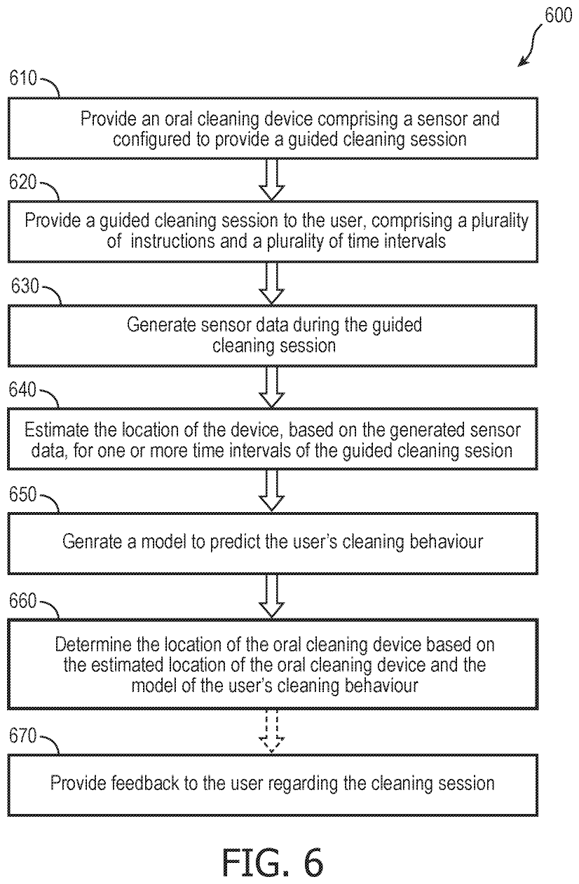

Referring to FIG. 6, in one embodiment, is a flowchart of a method 600 for estimating the location of an oral care device during a guided cleaning session comprising a plurality of time intervals. In step 610, an oral cleaning device 10 is provided. Alternatively, an oral cleaning system with device 10 and remote device 40 may be provided. The oral cleaning device or system can by any of the devices or systems described or otherwise envisioned herein.

At step 620 of the method, the guidance generator 46 provides a guided cleaning session to the user. The guided cleaning session can be preprogrammed and stored in guidance database 312, for example, or can be a learned guided cleaning session. The guided cleaning session includes a plurality of cleaning instructions to the user. For example, the guided cleaning session can include a plurality of time intervals separated by a cue to switch from a first location within the mouth to a second location within the mouth. The cue is generated by the feedback component 48 of oral care device 10, and can be a visual, audible, and/or haptic cue, among other cues.

At step 630 of the method, the sensor 28 of oral cleaning device 10 generates sensor data during one of the plurality of time intervals of the guided cleaning session. The sensor data is indicative of a position, motion, orientation, or other parameter or characteristic of the oral cleaning device at that location during that time interval. The sensor data is stored or sent to the controller 30 of the oral cleaning device and/or the controller 30b of the remote device. Accordingly, the controller obtains sensor data indicating a position or motion of the oral cleaning device.

At step 640 of the method, the location of the oral care device during one or more of the plurality of time intervals of the guided cleaning session is estimated. According to an embodiment, controller 30 receives the sensor data and analyzes the data to create an estimate of the location of the oral care device 10. For example, the estimate may be derived from a classification model such as a Gaussian model, decision tree, support vector machine, and many more. The classification model may be based on learned data. The output of the classifier can be, for example, a vector of probabilities.

At step 650 of the method, the system generates a model that predicts the user's cleaning behavior. According to an embodiment, the model is a statistical model such as a Hidden Markov Model or a set of constraints for the brushing path, order in which the mouth segments are brushed, such as: (i) the user brushes each mouth segment exactly once; or (ii) the user always starts in the lower left quadrant, among many other possible constraints.

At step 660 of the method, the system determines the location of the oral care device during one or more of the time intervals based on the estimated location of the oral care device and the model of the user's cleaning behavior. According to an embodiment, the system combines the location estimates or probabilities created at a classifier step with the generated user model. For example, if the behavior model is an HMM, the output of the classifier can be seen as emission probabilities and the most likely path can be obtained with a Viterbi algorithm, among other methods. As another example, if the behavior model comprises a predefined set of allowed paths, then the predicted path is the valid path that maximizes the product of segment probabilities.

At optional step 670 of the method, the device or system provides feedback to the user regarding the guided cleaning session. For example, the feedback may be provided to the user in real-time and/or otherwise during or after a cleaning session or immediately before the next cleaning session. The feedback may comprise an indication that the user has adequately or inadequately cleaned the mouth, including which segments of the mouth were adequately or inadequately cleaned, based on the localization data. Feedback generated by oral cleaning device 10 and/or remote device 40 can be provided to the user in any of a variety of different ways, including via visual, written, audible, haptic, or other types of feedback.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. An oral cleaning device configured to estimate a location of the device during a guided cleaning session comprising a plurality of time intervals, the oral cleaning device comprising:
a guidance generator configured to provide the guided cleaning session to the user, wherein the guided cleaning session comprises a plurality of time intervals separated by a cue to switch from a first location within the mouth to a second location within the mouth;
a sensor configured to generate sensor data during one of the plurality of time intervals, wherein the sensor data indicates a position or motion of the cleaning device;
a feedback component configured to generate the cues;
a controller configured to: (i) estimate, based on the generated sensor data, the location of the oral care device during the one of the plurality of time intervals; (ii) generate a model to predict the user's cleaning behavior; and (iii) determine the location of the oral care device during the one of the plurality of time intervals, based on the estimated location of the oral care device and the model of the user's cleaning behavior.

2. The cleaning device of claim 1, wherein the controller is configured to provide feedback to the user regarding the cleaning session.

3. The cleaning device of claim 1, wherein estimating the location of the oral cleaning device comprises estimating a probability for each of a plurality of locations within the user's mouth, that the oral cleaning device was located within the location during the one of the plurality of time intervals.

4. The cleaning device of claim 1, wherein the guided cleaning session further comprises a cue to begin the cleaning session and a cue to end the cleaning session.

5. The cleaning device of claim 1, wherein the cue is a visual cue, an audible cue, or a haptic cue.

6. An oral cleaning device configured to determine a user's compliance with a guided cleaning session, the oral cleaning device comprising:
a guidance generator module configured to generate a guided cleaning session comprising a plurality of time intervals separated by a cue to switch from a first location within the mouth to a second location within the mouth;
a sensor module configured to receive from a sensor (28) sensor data during one of the plurality of time intervals, wherein the sensor data indicates a position or motion of the cleaning device;
a feature extraction module configured to extract one or more features from the guided cleaning session and the sensor data;
a behavior model module configured to generate a model to predict the user's cleaning behavior; and
a location estimator module configured to:
estimate, based on the extracted features, the location of the oral care device during the one of the plurality of time intervals; and
determine, based on the estimated location of the oral care device and the model of the user's cleaning behavior, the location of the oral care device during the one of the plurality of time intervals.

7. The oral cleaning device of claim 6, further comprising a guidance database comprising one or more stored guided cleaning sessions.

8. The oral cleaning device of claim 6, wherein the cue is a visual cue, an audible cue, or a haptic cue.

9. A method for estimating a location of an oral cleaning device during a guided cleaning session comprising a plurality of time intervals, the method comprising the steps of:
providing an oral cleaning device comprising a sensor, a guidance generator, a feedback component, and a controller;
providing, by the guidance generator, a guided cleaning session to the user, wherein the guided cleaning session comprises a plurality of time intervals separated by a cue to switch from a first location within the mouth to a second location within the mouth, wherein the cue is generated by the feedback component;
generating, during one of the plurality of time intervals, sensor data from the sensor indicating a position or motion of the oral cleaning device;
estimating, by the controller based on the generated sensor data, the location of the oral cleaning device during the one of the plurality of time intervals;
generating a model to predict the user's cleaning behavior; and
determining the location of the oral cleaning device during the one of the plurality of time intervals, based on the estimated location of the oral cleaning device and the model of the user's cleaning behavior.

10. The method of claim 9, further comprising the step of providing feedback to the user regarding the cleaning session.

11. The method of claim 9, wherein the estimating step comprises estimating a probability for each of a plurality of locations within the user's mouth, that the oral cleaning device was located within the location during the one of the plurality of time intervals.

12. The method of claim 11, wherein the estimating step comprises a statistical model or a set of rules.

13. The method of claim 9, wherein the guided cleaning session further comprises a cue to begin the cleaning session and a cue to end the cleaning session.

14. The method of claim 9, wherein the guided cleaning session comprises only the cues.

15. The method of claim 9, wherein the cue is a visual cue, an audible cue, or a haptic cue.
